(19) United States
(12) Patent Application Publication
(10) Pub. No.: US 2026/0258630 A1
(43) Pub. Date: Sep. 3, 2026

(54) CONTROL DEVICE FOR LOADING MACHINE, CONTROL METHOD FOR LOADING MACHINE, AND REMOTE OPERATION SYSTEM

(71) Applicant: KOMATSU LTD., Tokyo (JP)

(72) Inventors: Tomoki KONDA, Tokyo (JP); Masao YAMAMURA, Tokyo (JP); Tomoyuki ETO, Tokyo (JP)

(21) Appl. No.: 19/489,476

(22) PCT Filed: Jun. 27, 2024
(86) PCT No.: PCT/JP2024/023367

§ 371 Date: Dec. 2, 2025

(30) Foreign Application Priority Data
Jul. 21, 2023 (JP) 2023-119377

(51) Int. Cl. E02F 3/43; E02F 9/12

(52) U.S. Cl. CPC E02F 3/437; E02F 9/123

(57) ABSTRACT

A control device for a loading machine determines, at time of automatic control to make a work tool move from above a loading target to a target position outside the loading target, a movement speed of a work implement based on a target revolution angle from a direction in which the work implement is directed at start of the automatic control to a direction in which the work implement is directed to the target position. The control device outputs a signal for moving the work implement at the determined movement speed.

### TECHNICAL FIELD

The present disclosure relates to a control device for a loading machine, a control method for the loading machine, and a remote operation system.

Priority is claimed on JP 2023-119377, filed Jul. 21, 2023, the content of which is incorporated herein by reference.

### BACKGROUND ART

Patent Document 1 discloses a technique for moving a work tool to an excavation point so that a loading target and the work tool do not interfere with each other in automatic control for a loading machine. According to the technique described in Patent Document 1, the work tool is lowered to a revolution end position at which the height of the work implement is slightly higher than an excavation position during revolution, and the work tool is lowered after the revolution ends, whereby it is possible to prevent the work tool from revolving while rubbing the ground.

### CITATION LIST

### Patent Literature

Patent Document 1: JP 7144252 B

### SUMMARY OF INVENTION

### Technical Problem

On the other hand, since the ground is not necessarily flat, when the work tool revolves while the height of the work tool is maintained to be slightly above the excavation position, the work tool may come into contact with a protruding portion of the ground.

An object of the present disclosure is to provide a control device for a loading machine, a control method for a loading machine, and a remote operation system capable of reducing a risk of a work tool coming into contact with the ground when the loading machine automatically revolves while lowering a work implement.

### Solution to Problem

According to a first aspect of the present disclosure, a control device for a loading machine is a control device for a loading machine including a revolving body configured to revolve about a revolution center, and a work implement attached to the revolving body and including a work tool, the control device determining, at time of automatic control to make the work tool move from above a loading target to a target position outside the loading target, a movement speed of the work implement based on a target revolution angle from a direction in which the work implement is directed at start of the automatic control to a direction in which the work implement is directed to the target position, and outputting a signal to make the work implement move at the movement speed determined.

### Advantageous Effects of Invention

According to the above aspect, it is possible to reduce the risk of a work tool coming into contact with the ground when a loading machine automatically revolves while lowering a work implement.

### BRIEF DESCRIPTION OF DRAWINGS

FIG. 1 is a schematic view illustrating a configuration of a loading machine according to a first embodiment.

FIG. 2 is a view illustrating an internal configuration of a cab according to the first embodiment.

FIG. 3 is a schematic block diagram illustrating a configuration of a control device according to the first embodiment.

FIG. 4 is a view illustrating an example of movement of the loading machine in a first revolution according to the first embodiment.

FIG. 5 is a view illustrating an example of movement of the loading machine in a second revolution according to the first embodiment.

FIG. 6 is a flowchart illustrating first revolution control by the control device according to the first embodiment.

FIG. 7 is a flowchart illustrating second revolution control by the control device according to the first embodiment.

FIG. 8 is a diagram illustrating an example of a control amount function according to the first embodiment.

FIG. 9 is a diagram illustrating an example of an upper limit value of a control amount according to the first embodiment.

FIG. 10 is a diagram illustrating an example of a target revolution angle and a target trajectory of the work implement according to a second embodiment.

FIG. 11 is a diagram illustrating an example of the target revolution angle and a relative angle of a bucket according to the second embodiment.

FIG. 12 is a diagram illustrating an example of a target revolution angle and a timing of lowering the work implement according to a third embodiment.

### DESCRIPTION OF EMBODIMENTS

### First Embodiment

Hereinafter, embodiments will be described in detail with reference to the drawings.

### Configuration of Loading Machine 100

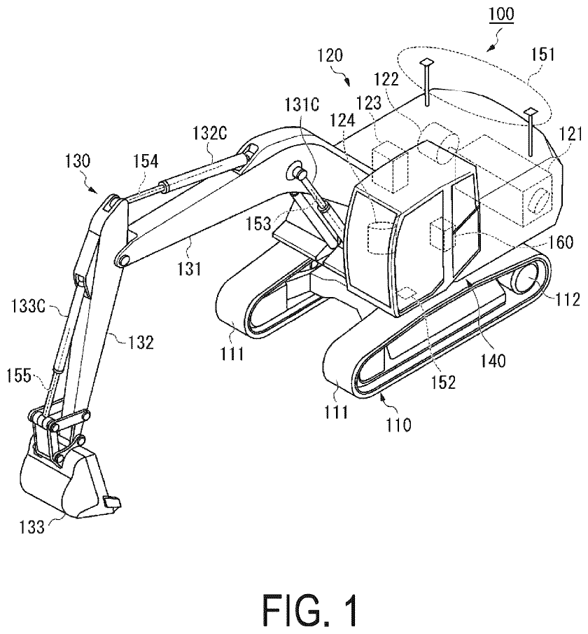

FIG. 1 is a schematic view illustrating a configuration of a loading machine 100 according to a first embodiment.

The loading machine 100 operates at a construction site, excavates a construction target such as earth and sand, and loads the construction target as a load onto a loading platform such as a vessel of a loading target T such as a dump truck. Examples of the loading machine 100 include a face shovel, a backhoe shovel, a rope shovel, and the like. Further, the loading machine 100 may be electrically driven or may be hydraulically driven. The loading machine 100 according to the first embodiment is a backhoe shovel. The loading machine 100 includes a traveling body 110, a revolving body 120, a work implement 130, and a cab 140. Examples of the loading target T include a dump truck, a hopper, and the like.

The traveling body 110 supports the loading machine 100 in a manner that enables travel. The traveling body 110 includes two endless tracks 111 provided on left and right sides and two travel motors 112 for driving the endless tracks 111. The traveling body 110 is an example of a support part.

The revolving body 120 is supported by the traveling body 110 so as to be revolvable about a revolution center.

The work implement 130 is driven by hydraulic pressure. The work implement 130 is supported at a front portion of the revolving body 120 so as to be drivable in an up-down direction.

The cab 140 is a space where an operator rides and operates the loading machine 100. The cab 140 is provided in a left front portion of the revolving body 120.

Here, a portion of the revolving body 120 where the work implement 130 is attached is referred to as a front portion. Further, in the revolving body 120, with reference to the front portion, a portion on a side opposite thereto is referred to as a rear portion, a portion on the left side is referred to as a left portion, and a portion on the right side is referred to as a right portion.

### Configuration of Revolving Body 120

The revolving body 120 includes an engine 121, a hydraulic pump 122, a control valve 123, and a revolution motor 124.

The engine 121 is a prime mover that drives the hydraulic pump 122. The engine 121 is an example of a power source.

The hydraulic pump 122 is a variable displacement pump driven by the engine 121. The hydraulic pump 122 supplies hydraulic oil to actuators (a boom cylinder 131C, an arm cylinder 132C, a bucket cylinder 133C, the travel motors 112, and the revolution motor 124) via the control valve 123.

The control valve 123 controls a flow rate of the hydraulic oil supplied from the hydraulic pump 122.

The revolution motor 124 is driven by the hydraulic oil supplied from the hydraulic pump 122 via the control valve 123 and revolves the revolving body 120.

### Configuration of Work Implement 130

The work implement 130 includes a boom 131, an arm 132, a bucket 133 as a work tool, the boom cylinder 131C, the arm cylinder 132C, and the bucket cylinder 133C. Other examples of the work tool include distal end attachments such as a clamshell bucket, a tilt bucket, a tilt rotator bucket, a grapple, and a lifting magnet.

A base end portion of the boom 131 is rotatably attached to the revolving body 120 via a boom pin. In the loading machine 100 illustrated in FIG. 1, the boom 131 is provided at a front center portion of the revolving body 120, but the position is not limited thereto, and the boom 131 may be attached offset in a left-right direction. In this case, the revolution center of the revolving body 120 is not located on an operation plane of the work implement 130.

The arm 132 couples the boom 131 and the bucket 133. A base end portion of the arm 132 is rotatably attached to a distal end portion of the boom 131 via an arm pin.

The bucket 133 is rotatably attached to a distal end portion of the arm 132 via a pin. The boom 131 and the arm 132 are members that support the bucket 133. The bucket 133 serves as a container for accommodating excavated earth and sand. The bucket 133 is attached with an opening thereof facing the revolving body 120 (rearward). That is, the loading machine 100, which is a backhoe shovel, performs excavation by pulling the bucket 133 in front of the revolving body 120.

The boom cylinder 131C is a hydraulic cylinder for actuating the boom 131. A base end portion of the boom cylinder 131C is attached to the revolving body 120. A distal end portion of the boom cylinder 131C is attached to the boom 131.

The arm cylinder 132C is a hydraulic cylinder for driving the arm 132. A base end portion of the arm cylinder 132C is attached to the boom 131. A distal end portion of the arm cylinder 132C is attached to the arm 132.

The bucket cylinder 133C is a hydraulic cylinder for driving the bucket 133. A base end portion of the bucket cylinder 133C is attached to the arm 132. A distal end portion of the bucket cylinder 133C is attached to a link mechanism that turns the bucket 133.

### Configuration of Cab 140

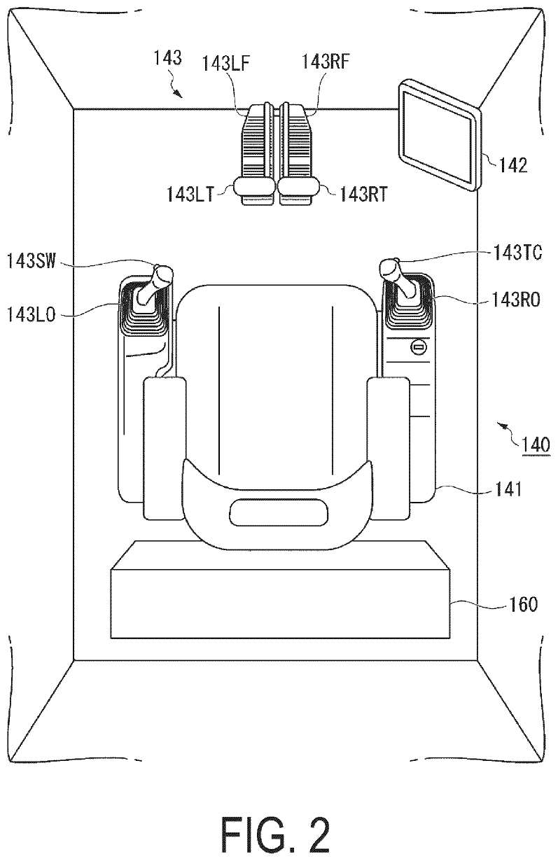

FIG. 2 is a view illustrating an internal configuration of the cab 140 according to the first embodiment.

An operator seat 141, an operation terminal 142, and an operation device 143 are provided in the cab 140. The operation terminal 142 is provided in the vicinity of the operator seat 141 and is a user interface with a control device 160 described below. The operation terminal 142 is a display device constituted by a touch panel, for example, and may include an operation unit to be operated by an operator and an input reception unit that receives operations. Further, the display device displays measurement data of an engine water temperature gauge, a fuel gauge, and the like. Further, the operation terminal 142 may include a display unit such as a liquid crystal display (LCD). The touch panel is an example of a display unit.

The operation device 143 is a device for driving the traveling body 110, the revolving body 120, and the work implement 130 by manual operation by the operator. The operation device 143 includes a left operation lever 143LO, a right operation lever 143RO, a left foot pedal 143LF, a right foot pedal 143RF, a left travel lever 143LT, a right travel lever 143RT, a start switch 143SW, and a teaching switch 143TC.

The left operation lever 143LO is provided on the left side of the operator seat 141. The right operation lever 143RO is provided on the right side of the operator seat 141.

The left operation lever 143LO is an operation mechanism for performing a revolution operation of the revolving body 120 and an excavation/dumping operation of the arm 132. Specifically, when the operator of the loading machine 100 tilts the left operation lever 143LO forward, the arm 132 performs the dumping operation. When the operator of the loading machine 100 tilts the left operation lever 143LO rearward, the arm 132 performs the excavation operation. When the operator of the loading machine 100 tilts the left operation lever 143LO rightward, the revolving body 120 revolves to the right. Further, when the operator of the loading machine 100 tilts the left operation lever 143LO leftward, the revolving body 120 revolves to the left. Note that, in another embodiment, the revolving body 120 may revolve clockwise or counterclockwise when the left operation lever 143LO is tilted in a front-rear direction, and the arm 132 may perform the excavation operation or the dumping operation when the left operation lever 143LO is tilted in the left-right direction.

The right operation lever 143RO is an operation mechanism for performing the excavation/dumping operation of the bucket 133 and a raising/lowering operation of the boom 131. Specifically, when the operator of the loading machine 100 tilts the right operation lever 143RO forward, the lowering operation of the boom 131 is executed. When the operator of the loading machine 100 tilts the right operation lever 143RO rearward, the raising operation of the boom 131 is executed. When the operator of the loading machine 100 tilts the right operation lever 143RO rightward, the dumping operation of the bucket 133 is performed. Further, when the operator of the loading machine 100 tilts the right operation lever 143RO leftward, the excavation operation of the bucket 133 is performed. Note that, in another embodiment, the bucket 133 may perform the dumping operation or the excavation operation when the right operation lever 143RO is tilted in the front-rear direction, and the boom 131 may perform the raising operation or the lowering operation when the right operation lever 143RO is tilted in the left-right direction.

The left foot pedal 143LF is disposed on the left side of a floor surface in front of the operator seat 141. The right foot pedal 143RF is disposed on the right side of the floor surface in front of the operator seat 141. The left travel lever 143LT is pivotally supported by the left foot pedal 143LF and is configured so that the tilting of the left travel lever 143LT and a depression of the left foot pedal 143LF are interlocked with each other. The right travel lever 143RT is pivotally supported by the right foot pedal 143RF and is configured so that the tilting of the right travel lever 143RT and a depression of the right foot pedal 143RF are interlocked with each other.

The left foot pedal 143LF and the left travel lever 143LT correspond to the rotational driving of a left crawler track of the traveling body 110. Specifically, when the operator of the loading machine 100 tilts the left foot pedal 143LF or the left travel lever 143LT forward, the left crawler track rotates in the forward direction. Further, when the operator of the loading machine 100 tilts the left foot pedal 143LF or the left travel lever 143LT rearward, the left crawler track rotates in a rearward direction.

The right foot pedal 143RF and the right travel lever 143RT correspond to the rotational driving of a right crawler track of the traveling body 110. Specifically, when the operator of the loading machine 100 tilts the right foot pedal 143RF or the right travel lever 143RT frontward, the right crawler track rotates in a forward direction. Further, when the operator of the loading machine 100 tilts the right foot pedal 143RF or the right travel lever 143RT rearward, the right crawler track rotates in the rearward direction.

The start switch 143SW is provided, for example, at a handle portion of the left operation lever 143LO. The start switch 143SW is disposed so as to be located in the vicinity of the operator seated on the operator seat 141. When the start switch 143SW is operated, an automatic control instruction signal is output to the control device 160. The control device 160, when receiving input of the automatic control instruction signal, starts the automatic control.

The teaching switch 143TC is provided, for example, at a handle portion of the right operation lever 143RO. The teaching switch 143TC is a switch for teaching a control point of the bucket 133. When the teaching switch 143TC is operated, a teaching signal is output to the control device 160. When the input of the teaching signal is received, the control device 160 identifies a point at which the bucket 133 is currently located as the control point.

The automatic control refers to the loading machine 100 autonomously controlling the driving of the work implement 130 and the revolving body 120 in order to realize a predetermined operation. The automatic control in the first embodiment is control in which the loading machine 100 autonomously performs a first revolution which is a series of operations of revolving from a state in which the bucket 133 is positioned to the side of the loading target T by excavation of the excavation target to an orientation directed to the loading target T while raising the boom 131, and a second revolution which is a series of operations of revolving from a state in which the bucket 133 is positioned above the loading target T by loading to a predetermined orientation while lowering the boom 131. The side of the loading target T refers to outside of the loading platform on which a load is to be loaded, such as a vessel. Note that the automatic control according to another embodiment may perform only the second revolution. In the first embodiment, target orientations of the revolving body 120 and target postures of the bucket 133 in the first revolution and the second revolution are respectively set to orientations and postures designated in advance. Typically, the excavation target is at a position lower than a height of the loading target T. Therefore, the loading machine 100 controls the driving of the work implement 130 so that the loading target T and the work implement 130 do not come into contact with each other in the first revolution and the second revolution. Details of the automatic control will be described below.

The automatic control executed each time the start switch 143SW is operated switches between the first revolution and the second revolution. Further, in another embodiment, the operation device 143 may include two of the start switches 143SW, and the first revolution and the second revolution may be respectively assigned thereto.

### Configuration of Measurement System

As illustrated in FIG. 1, the loading machine 100 includes a position and orientation calculator 151, an inclination measuring instrument 152, a boom stroke sensor 153, an arm stroke sensor 154, and a bucket stroke sensor 155.

The position and orientation calculator 151 calculates a position of the revolving body 120 and an orientation in which the revolving body 120 is directed. The position and orientation calculator 151 includes two receivers that receive positioning signals from artificial satellites constituting the global navigation satellite system (GNSS). The two receivers are installed at different positions of the revolving body 120. The position and orientation calculator 151 detects a position of a representative point (origin of shovel coordinate system) of the revolving body 120 in a site coordinate system based on the positioning signals received by the receivers.

Using the positioning signals received by the two receivers, the position and orientation calculator 151 calculates the orientation in which the revolving body 120 is directed as a relationship between an installation position of one receiver and an installation position of the other receiver. The orientation in which the revolving body 120 is directed is a direction orthogonal to a front surface of the revolving body 120. The orientation in which the revolving body 120 is directed is equal to a horizontal component in an extending direction of a straight line extending from the boom 131 to the bucket 133 of the work implement 130.

The inclination measuring instrument 152 measures an acceleration and an angular velocity of the revolving body 120, and detects a posture (for example, roll angle, pitch angle, and yaw angle) and a revolution speed of the revolving body 120 based on the measurement result. The inclination measuring instrument 152 is installed, for example, on a lower surface of the revolving body 120. As the inclination measuring instrument 152, an inertial measurement unit (IMU) can be used, for example.

The boom stroke sensor 153 is attached to the boom cylinder 131C and detects a cylinder length of the boom cylinder 131C. The cylinder length of the boom cylinder 131C can be converted into a relative angle of the boom 131 with respect to the revolving body 120.

The arm stroke sensor 154 is attached to the arm cylinder 132C and detects a cylinder length of the arm cylinder 132C. The cylinder length of the arm cylinder 132C can be converted into a relative angle of the arm 132 with respect to the boom 131.

The bucket stroke sensor 155 is attached to the bucket cylinder 133C and detects a cylinder length of the bucket cylinder 133C. The cylinder length of the bucket cylinder 133C can be converted into a relative angle of the bucket 133 with respect to the arm 132.

The loading machine 100 according to the first embodiment identifies an angle of each link part of the work implement 130 using the boom stroke sensor 153, the arm stroke sensor 154, and the bucket stroke sensor 155, but is not limited thereto in other embodiments. For example, in another embodiment, a potentiometer that detects a relative rotation angle of a link part may be provided, or a tilt sensor that detects a ground angle of each link part may be provided instead of the stroke sensor.

### Configuration of Control Device 160

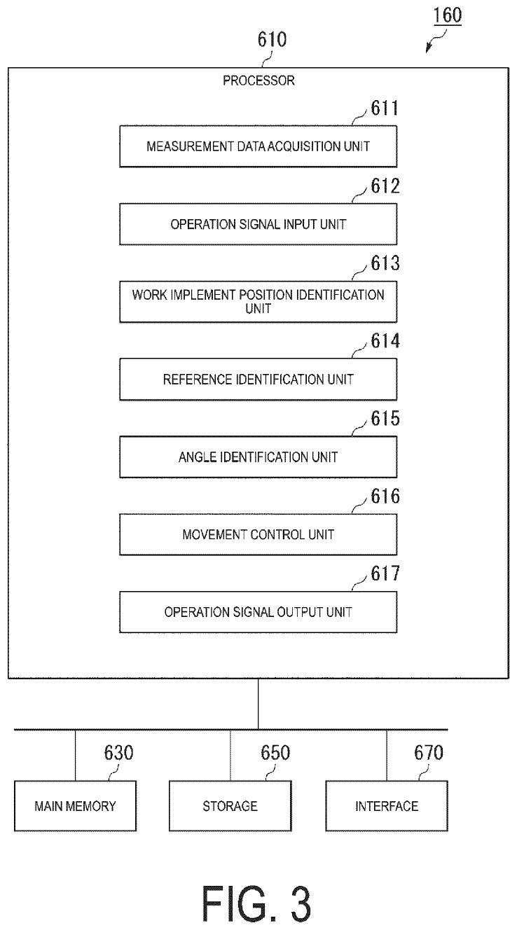

FIG. 3 is a schematic block diagram illustrating a configuration of the control device 160 according to the first embodiment.

The loading machine 100 includes the control device 160. The control device 160 may be mounted on the operation terminal 142, or may be provided separately from the operation terminal 142 and receive inputs and outputs from the operation terminal 142. The control device 160 receives operation signals from the operation device 143. The control device 160 drives the work implement 130, the revolving body 120, and the traveling body 110 by outputting the received operation signal or an operation signal generated for the automatic control to the control valve 123. Hereinafter, the operation signal received from the operation device 143 is referred to as a manual operation signal, and the operation signal generated for the automatic control is referred to as an automatic operation signal. The automatic operation signal is composed of operation signals for driving the revolving body 120 and the work implement 130, and does not include an operation signal for driving the traveling body 110. When a manual operation signal from the operator is received during the automatic control, the control device 160 may stop the automatic control.

The control device 160 is a computer including a processor 610, a main memory 630, a storage 650, and an interface 670. The storage 650 stores a program. The processor 610 reads the program from the storage 650, loads the program into the main memory 630, and executes processing according to the program.

Examples of the storage 650 include a semiconductor memory, a magnetic disk, a magneto-optical disk, an optical disk, and the like. The storage 650 may be an internal medium directly connected to a common communication line of the control device 160, or may be an external medium connected to the control device 160 via the interface 670. The main memory 630 and the storage 650 are non-transitory tangible storage media.

With execution of the program, the processor 610 includes a measurement data acquisition unit 611, an operation signal input unit 612, a work implement position identification unit 613, a reference identification unit 614, an angle identification unit 615, a movement control unit 616, and an operation signal output unit 617.

The measurement data acquisition unit 611 acquires measurement data acquired by the measurement system of the loading machine 100. Specifically, the measurement data acquisition unit 611 acquires measurement data from each of the position and orientation calculator 151, the inclination measuring instrument 152, the boom stroke sensor 153, the arm stroke sensor 154, and the bucket stroke sensor 155. The measurement data acquisition unit 611 calculates an angle of the revolving body 120 by integrating the angular velocity of the revolving body 120 measured by the inclination measuring instrument 152.

The operation signal input unit 612 receives input of operation signals manually operated by the operator from the operation device 143. The operation signals include a drive signal for raising or lowering the boom 131, a drive signal for raising or lowering the arm 132, a drive signal for causing the bucket 133 to dump or excavate, a drive signal for revolving the revolving body 120 rightward or leftward, a drive signal for causing the traveling body 110 to travel, and an automatic control instruction signal for the loading machine 100.

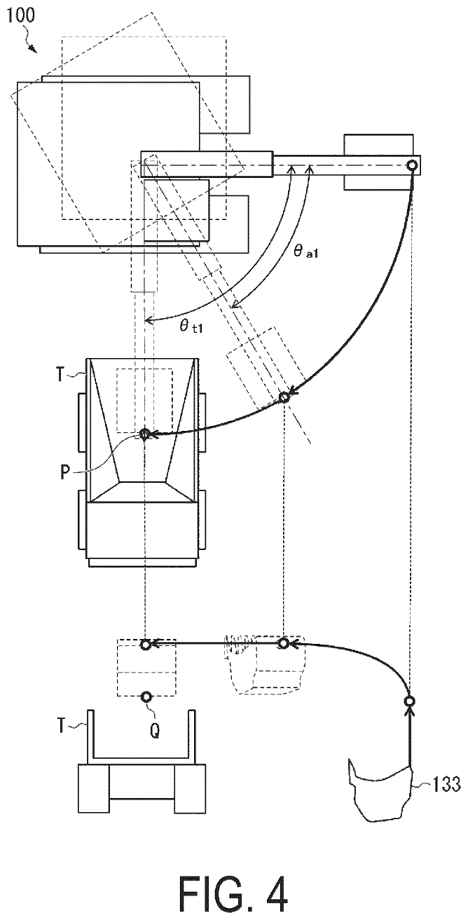

The work implement position identification unit 613 identifies a position of a distal end P of the arm 132 (FIG. 4) and a position of a lowest point Q of the bucket 133 (FIG. 4) in a vehicle coordinate system with reference to the revolving body 120 based on the measurement data acquired by the measurement data acquisition unit 611. The lowest point Q of the bucket 133 is a point of an outer shape of the bucket 133 at which a distance from a ground surface is shortest.

The work implement position identification unit 613 determines a vertical direction component and a horizontal direction component of a length of the boom 131 based on an inclination angle of the boom 131 and a known length of the boom 131 (distance from the pin at the base end portion to the pin at the distal end portion). Similarly, the work implement position identification unit 613 determines a vertical direction component and a horizontal direction component of a length of the arm 132. The work implement position identification unit 613 identifies a position separated from the position of the loading machine 100 by the sum of the vertical direction components and the sum of the horizontal direction components of the lengths of the boom 131 and the arm 132 in a direction identified from the orientation and the posture of the loading machine 100 as the position of the distal end P of the arm 132. Further, the work implement position identification unit 613 identifies the position of the lowest point Q of the bucket 133 based on an inclination angle of the bucket 133 and a known shape of the bucket 133. For example, the work implement position identification unit 613 calculates the position of each of a plurality of points on an outer shell of the bucket 133 based on the inclination angle of the bucket 133, and identifies the point having the lowest height among the plurality of points as the lowest point Q. Further, for example, the work implement position identification unit 613 may set a point obtained by downwardly offsetting a distance between a point of the bucket 133 farthest from a bucket pin and the bucket pin in a height direction from the bucket pin as the lowest point Q. Further, for example, the work implement position identification unit 613 may set a point obtained by downwardly offsetting an amount of the maximum bucket movable range in the height direction from the bucket pin as the lowest point Q. Further, the work implement position identification unit 613 may set a point offsetting the height with a margin from the height identified above, accounting for control errors and measurement errors, as the lowest point Q.

Before execution of the automatic control, the reference identification unit 614 receives teaching of an excavation preparation position, an interference avoidance position, and a loading position of the bucket 133 from the operator as reference points of the automatic control. The teaching is performed by the following procedure, for example.

The reference identification unit 614 causes the operation terminal 142 to display an instruction for moving the bucket 133 to the excavation preparation position. The operator operates the operation device 143 to move the bucket 133 to the excavation preparation position, and operates the teaching switch 143TC to output the teaching signal to the control device 160. The reference identification unit 614 records, in the storage 650, the posture of the work implement 130 identified by the work implement position identification unit 613 as the target posture of the second revolution, the position of the distal end P of the arm 132 as the target position of the second revolution, and the orientation in which the revolving body 120 is directed as the target orientation of the second revolution.

Next, the reference identification unit 614 causes the operation terminal 142 to display an instruction for moving the bucket 133 to the interference avoidance position corresponding to a position having a height of an upper end of a wall of the vessel of the loading target T and where the work implement 130 and the loading target T do not overlap in plan view from above. Note that the wall of the vessel used for teaching may be any one of a side wall, a front wall, or a rear wall of the vessel. The operator operates the operation device 143 to move the bucket 133 to the interference avoidance position, and operates the teaching switch 143TC to output the teaching signal to the control device 160. The interference avoidance positions are input with respect to both a right end and a left end of the loading target T. Accordingly, the reference identification unit 614 can identify the range of the loading platform of the loading target T. Note that a height of each interference avoidance position may be a height obtained by offsetting the height with a margin in an upward direction accounting for control errors and measurement errors.

The reference identification unit 614 records, in the storage 650, the height of the lowest point Q of the bucket 133 identified by the work implement position identification unit 613 as a wall height Ht of the loading target T, and the orientation in which the revolving body 120 is directed as the interference avoidance orientation. Next, the reference identification unit 614 causes the operation terminal 142 to display an instruction for moving the bucket 133 to the loading position above the loading target T. The operator operates the operation device 143 to move the bucket 133 to the loading position, and operates the teaching switch 143TC to output the teaching signal to the control device 160. The reference identification unit 614 records, in the storage 650, the posture of the work implement 130 as the target posture of the first revolution, the position of the distal end P of the arm 132 as the target position of the first revolution, and the orientation in which the revolving body 120 is directed identified by the work implement position identification unit 613 as the target orientation of the first revolution. Further, the height of the lowest point Q of the bucket 133 identified at the loading position may be set as the wall height Ht. Further, in another embodiment, the height of the loading target T does not necessarily need to be the wall height Ht that is the height of the side wall of the loading platform, and may be a height of a highest point of the loading target T overall.

The angle identification unit 615 identifies, as a target revolution angle, an angle between an initial orientation in which the revolving body 120 is directed when the automatic control instruction signal is input to the operation signal input unit 612 and the target orientation recorded in the storage 650. The target revolution angle varies depending on the revolution direction. Therefore, the angle identification unit 615 receives an input of the revolution direction from the operation terminal 142, and identifies the target revolution angle based on the input revolution direction. Further, the target revolution angle may be identified by calculating the revolution angle for each of the counterclockwise revolution and the clockwise revolution and setting the minimum revolution angle as the target revolution angle. The angle identification unit 615 identifies, as an interference avoidance angle, an angle between the initial orientation in which the revolving body 120 is directed when the automatic control instruction signal is input to the operation signal input unit 612 and a interference avoidance orientation recorded in the storage 650. The interference avoidance angle is a revolution angle at which the work implement 130 and the loading target T do not overlap each other in plan view from above. The target revolution angle includes a first target revolution angle which is the target revolution angle for the first revolution and a second target revolution angle which is the target revolution angle for the second revolution.

When the operation signal input unit 612 receives input of the automatic control instruction signal, the movement control unit 616 generates an automatic operation signal for realizing the automatic control. When the automatic control instruction signal is input, automatic control for realizing the first revolution for moving the bucket 133 to the loading position or automatic control for realizing the second revolution for moving the bucket 133 to the excavation preparation position is executed. The movement control unit 616 determines whether to execute the first revolution or to execute the second revolution in the automatic control depending on whether the bucket 133 is within the range of the loading target T in plan view from above when the automatic control instruction signal is input. When the bucket 133 is not within the range of the loading platform of the loading target T, the movement control unit 616 executes the first revolution, and when the bucket 133 is within the range of the loading platform of the loading target T, the movement control unit 616 executes the second revolution. At this time, based on the wall height Ht and the interference avoidance angle stored in the storage 650, the movement control unit 616 controls the revolving body 120 and the work implement 130 so that the loading target T and the work implement 130 do not come into contact with each other.

Specifically, in the first revolution, the movement control unit 616 implements the combined operation of the revolving body 120 and the work implement 130 before a first interference avoidance angle θₐ₁ (FIG. 4) is reached. In the first revolution, when the height of the bucket 133 does not reach the height of the loading position before the revolution angle of the revolving body 120 reaches the first interference avoidance angle θₐ₁ (FIG. 4), the movement control unit 616 does not output a revolution operation signal for the revolving body 120, and outputs only an operation signal for the work implement 130. On the other hand, when the height of the bucket 133 reaches the height of the loading position before the revolution angle by revolution reaches the first interference avoidance angle θₐ₁, the movement control unit 616 outputs a revolution operation signal for the revolving body 120 and an operation signal for the work implement 130 and implements the combined operation of the revolving body 120 and the work implement 130. After the height of the bucket 133 reaches the height of the loading position at the first interference avoidance angle θₐ₁ (FIG. 4), the movement control unit 616 causes the revolving body 120 to revolve without moving the work implement 130.

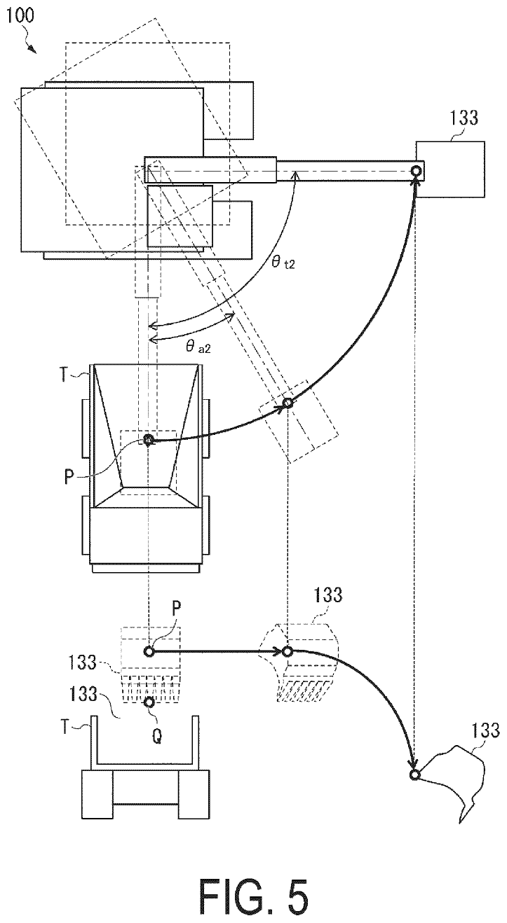

Further, the movement control unit 616 performs control so that the lowest point of the bucket 133 is not lowered before the revolution angle of the revolving body 120 reaches a second interference avoidance angle θₐ₂ (FIG. 5) in the second revolution of a revolution opposite to the first revolution. The control in which the lowest point is not lowered may be control in which the revolving body 120 is revolved without moving the work implement 130 while maintaining the height of the lowest point, or may be control in which a gap is provided between the loading target T and the bucket 133 by making the lowest point higher than the lowest point before control. After the revolution angle reaches the second interference avoidance angle θₐ₂, the movement control unit 616 outputs a revolution operation signal for the revolving body 120 and an operation signal for the work implement 130 to realize a combined operation of the revolving body 120 and the work implement 130.

The operation signal output unit 617 outputs, to the control valve 123, the manual operation signal input to the operation signal input unit 612 or the automatic operation signal generated by the movement control unit 616.

### Operation During Automatic Control

Here, movement of the loading machine 100 during the automatic control according to the first embodiment will be described with reference to the drawings.

FIG. 4 is a view illustrating an example of the movement of the loading machine 100 in the first revolution according to the first embodiment. FIG. 5 is a view illustrating an example of the movement of the loading machine 100 in the second revolution according to the first embodiment.

When the automatic control according to the first revolution starts, the control device 160, as illustrated in FIG. 4, first starts driving the work implement 130 (the boom 131, the arm 132, and the bucket 133), and moves the bucket 133 upward by the raising operation of the boom 131. The target position of the bucket 133 according to the first revolution is the loading position above the loading target T. After a delay, the control device 160 starts revolution of the revolving body 120. The control device 160 adjusts a revolution start timing so that the posture of the work implement 130 reaches the target posture related to the first revolution before the revolution angle of the revolving body 120 matches the first interference avoidance angle θₐ₁. Note that, before the revolution angle of the revolving body 120 matches the first interference avoidance angle θₐ₁, when the posture of the work implement 130 reaches the target posture in the first revolution, that is, when the height of the lowest point Q of the bucket 133 is higher than the wall height Ht of the loading target T, the work implement 130 will not come into contact with the loading target T by the revolution of the revolving body 120. Note that, when the work implement 130 is driven simultaneously with the revolution and the posture of the work implement 130 becomes the target posture in the first revolution before the revolution angle reaches the first interference avoidance angle θₐ₁, the control device 160 may start the driving of the work implement 130 and the revolution simultaneously. Subsequently, when the bucket 133 reaches the loading position, the automatic control is ended. Subsequently, the operator manually performs the dumping operation in which the bucket 133 is turned in a dumping direction.

When the automatic control related to the second revolution starts, the control device 160 starts the revolution of the revolving body 120. Until the revolution angle of the revolving body 120 exceeds the second interference avoidance angle θₐ₂, the control device 160 revolves the revolving body 120 without moving the work implement 130 and maintains the height of the lowest point of the bucket 133. When the revolution angle of the revolving body 120 exceeds the second interference avoidance angle θₐ₂, the control device 160 drives the boom 131, the arm 132, and the bucket 133. At this time, the control device 160 determines the movement speeds of the boom 131, the arm 132, and the bucket 133 based on a second target revolution angle θₜ₂. Here, the movement speed of the work implement 130 determined by the control device 160 is a movement speed of the work implement 130 on the drive plane. The control device according to the present embodiment determines the movement speed according to the second target revolution angle θₜ₂ which is an angle between the initial orientation and the target orientation, but is not limited to this in another embodiment. For example, the control device according to another embodiment may determine the movement speed based on the target revolution angle from the interference avoidance orientation to the initial orientation. Since the target revolution angle from the interference avoidance orientation to the initial orientation is an angle (θₜ₂−θₐ₂) of difference between the second interference avoidance angle θₐ₂ and the second target revolution angle θₜ₂, the control device determines the movement speed according to the second target revolution angle θₜ₂ in this case as well. Further, the determination of the movement speed by the control device according to the second target revolution angle θₜ₂ can be regarded as being equivalent to the determination of the movement speed according to the target revolution angle from the interference avoidance orientation to the initial orientation. Specifically, the control device 160 sets slower movement speeds for the boom 131, the arm 132, and the bucket 133 in accordance with a larger second target revolution angle θₜ₂. When the revolution angle of the revolving body 120 reaches the second target revolution angle θₜ₂, the control device 160 ends the driving of the revolving body 120. Further, when the posture of the work implement 130 reaches the target posture at the timing of starting excavation, the control device 160 ends the driving of the work implement 130. In the second revolution, the control device 160 according to the first embodiment revolves the revolving body 120 without moving the work implement 130 until the revolution angle of the revolving body 120 exceeds the second interference avoidance angle θₐ₂, but the revolution is not limited thereto. For example, the control device 160 according to another embodiment may revolve the revolving body 120 while moving the work implement 130 so that the height of the lowest point of the bucket 133 does not change. Further, when the bucket 133 is higher than the wall height Ht, the control device 160 according to the embodiment may revolve the revolving body 120 while lowering the work implement 130 to such an extent that the height of the lowest point of the bucket 133 is not lower than the wall height Ht.

FIGS. 4 and 5 illustrate an example in which a positional relationship between the excavation position and the loading target T is approximately 90 degrees about the revolving body 120, but the positional relationship is not limited thereto in other embodiments. For example, in another embodiment, the positional relationship between the excavation position and the loading target T may be another revolution angle position such as approximately 180 degrees about the revolving body 120.

### Operation of Control Device 160

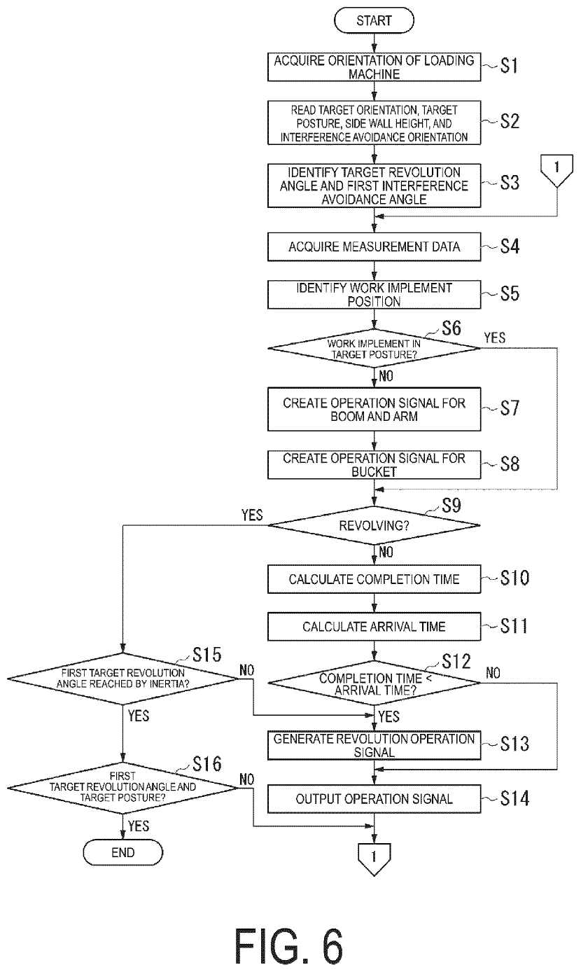

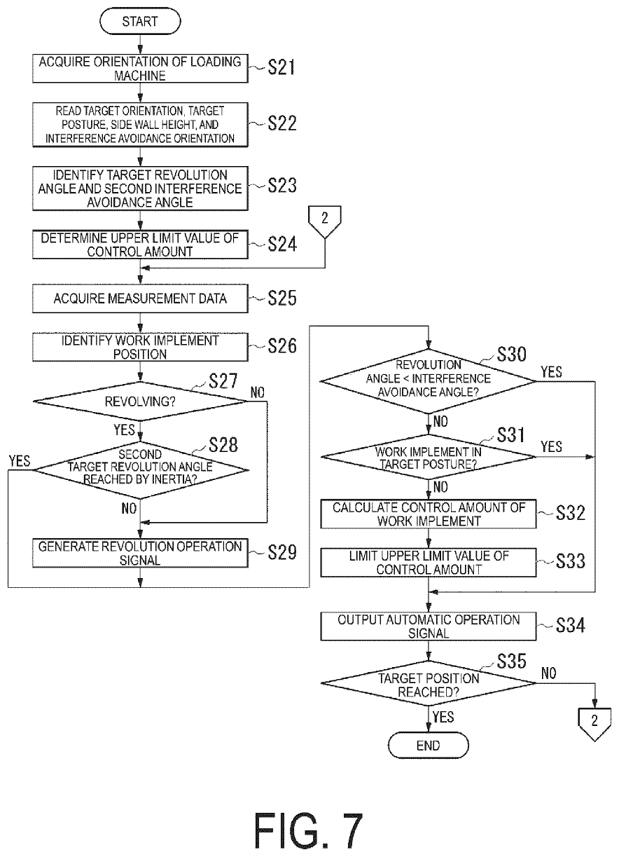

FIG. 6 is a flowchart illustrating first revolution control by the control device 160 according to the first embodiment. FIG. 7 is a flowchart illustrating second revolution control by the control device 160 according to the first embodiment.

When the start switch 143SW is operated by the operator, the operation signal input unit 612 of the control device 160 receives input of an automatic control instruction signal. When the automatic loading instruction signal is input, the control device 160 determines whether to execute the first revolution or to execute the second revolution based on whether the bucket 133 is within the range on the loading platform of the loading target T in plan view from above.

In executing the first revolution, the control device 160 executes the first revolution control illustrated in FIG. 6. First, the measurement data acquisition unit 611 acquires the measurement data of the orientation of the loading machine 100 (step S1). The movement control unit 616 reads the target orientation (orientation directed to the loading target T) of the revolving body 120, the target posture, the wall height Ht of the loading target T, and the interference avoidance orientation from the storage 650 (step S2). The angle identification unit 615 identifies the first target revolution angle θₜ₁ and the first interference avoidance angle θₐ₁ based on the orientation in which the revolving body 120 is directed identified in step S1 and the target orientation and the interference avoidance orientation read in step S2 (step S3).

Next, the measurement data acquisition unit 611 acquires the measurement data of each of the position, the orientation, the inclination angle, and the revolution speed of the loading machine 100, as well as the measurement data of the cylinder length of each cylinder (step S4). The work implement position identification unit 613 identifies the posture of the work implement 130 based on the measurement data (step S5). Thus, the work implement position identification unit 613 identifies the position of the distal end P of the arm 132, the position of the lowest point Q of the bucket 133, and the posture of the bucket 133.

The movement control unit 616 generates an automatic operation signal for moving the bucket 133 to above the loading target T based on the target orientation, the target posture, and the wall height Ht read in step S2 and the first interference avoidance angle θₐ₁ identified in step S3. That is, a movement control unit 616 generates the automatic operation signal so that the lowest point Q of the bucket 133 reaches the loading position represented by the target orientation and the target posture from the position of the lowest point Q at the start of the first revolution control via the interference avoidance position represented by the wall height Ht and the first interference avoidance angle θₐ₁. At this time, the movement control unit 616 generates an automatic operation signal for the bucket 133 so that the ground angle of the bucket 133 does not change even when the boom 131 and the arm 132 are driven.

Specifically, the movement control unit 616 generates the automatic operation signal by the following procedure.

First, the movement control unit 616 determines whether the posture of the work implement 130 identified in step S5 approximates the target posture acquired in step S1 (step S6). For example, when a difference between the position of the distal end of the arm 132 in the target posture and the current position of the distal end of the arm 132 is equal to or less than a predetermined value, the movement control unit 616 determines that the posture of the work implement 130 is approximate to the target posture. When the posture of the work implement 130 is not approximate to the target posture (step S6: NO), the movement control unit 616 generates an automatic operation signal for bringing the boom 131 and the arm 132 close to the target posture (step S7).

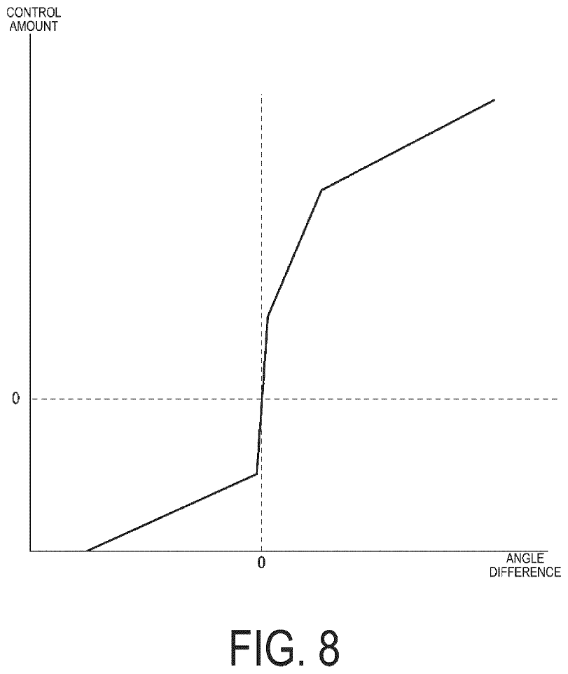

At this time, the movement control unit 616 generates the automatic operation signal based on the relative angles of the boom 131 and the arm 132 identified from the measurement data acquired in step S4. Specifically, the movement control unit 616 determines the control amount of the automatic operation signal of the boom 131, that is, the angular velocity, by substituting the difference between the measurement value of the relative angle of the boom 131 and the value of the relative angle of the boom 131 related to the target posture into a predetermined control amount function. FIG. 8 is a diagram illustrating an example of the control amount function according to the first embodiment. According to FIG. 8, the control amount increases as the difference in the relative angle increases. In the graph illustrated in FIG. 8, the right side represents the angle difference when the angle related to the measurement value is smaller than the angle of the target posture, and the left side represents the angle difference when the angle related to the measurement value is larger than the angle of the target posture. In the graph illustrated in FIG. 8, the upper side represents the control amount in the upward direction, and the lower side represents the control amount in the downward direction. For example, when the angle difference obtained by subtracting the measurement value of the relative angle of the boom 131 from the relative angle of the boom 131 related to the target posture is 0 or more, the movement control unit 616 identifies the control amount for moving the boom 131 in the upward direction. For example, when the angle difference obtained by subtracting the measurement value of the relative angle of the boom 131 from the relative angle of the boom 131 related to the target posture is 0 or less, the movement control unit 616 identifies the control amount for moving the boom 131 in the downward direction. The movement control unit 616 determines the control amount of the automatic operation signal for the arm 132 based on the measurement value of the relative angle of the arm 132 and the control amount function, as in the case of the boom 131. In another embodiment, the movement control unit 616 may obtain the control amount by substituting the difference between a target cylinder length and an actual cylinder length into a predetermined control amount function. The control amount may be a cylinder speed or a spool stroke command value. The format of the control amount function is not limited to that illustrated in FIG. 8. For example, the control amount function may include a dead zone in the vicinity of a point where the explanatory variable (the angle difference, the difference between the target cylinder length and the actual cylinder length) is zero.

Further, the movement control unit 616 calculates the sum of the driving speeds of the boom 131 and the arm 132 based on the generated automatic operation signal of the boom 131 and the arm 132, and generates an automatic operation signal for driving the bucket 133 at the same speed as the sum of the driving speeds (step S8). Thus, the movement control unit 616 can generate an operation signal for keeping the ground angle of the bucket 133.

The movement control unit 616 determines whether the work implement 130 is revolving (step S9). For example, when the revolution speed of the revolving body 120 is equal to or higher than a predetermined speed, the movement control unit 616 determines that the revolution is in progress. When the work implement 130 is not revolving (step S9: NO), the movement control unit 616 calculates a completion time for the work implement 130 to reach the target posture based on the speeds of the boom 131 and the arm 132 identified in step S7 (step S10). Further, the movement control unit 616 calculates an arrival time for the revolution angle to reach the first interference avoidance angle θₐ₁ identified in step S3 when the revolving body 120 starts revolving (step S11). The movement control unit 616 determines whether the completion time calculated in step S10 is shorter than the arrival time calculated in step S11 (step S12). That is, the movement control unit 616 determines whether the work implement 130 will take the target posture when the revolution angle reaches the first interference avoidance angle θₐ₁.

When the completion time is equal to or longer than the arrival time (step S12: NO), that is, when the work implement 130 will not take the target posture before the revolution angle reaches the first interference avoidance angle θₐ₁, the movement control unit 616 does not generate a revolution operation signal for the revolving body 120. On the other hand, when the completion time is shorter than the arrival time (step S12: YES), that is, when the work implement 130 will take the target posture before the revolution angle reaches the first interference avoidance angle θₐ₁, the movement control unit 616 generates a revolution operation signal for the revolving body 120 (step S13). As a result, the control device 160 can prevent the work implement from coming into contact with the loading target T due to the work implement 130 revolving while remaining at a low height.

The operation signal output unit 617 outputs the generated automatic operation signal to the control valve 123 (step S14). Thus, the loading machine 100 is driven. Then, the control device 160 returns the processing to step S4 and continues the control.

On the other hand, when the determination is made in step S9 that the work implement 130 is revolving (step S9: YES), the movement control unit 616 determines whether the revolution angle will reach the first target revolution angle by revolution due to inertia when the revolution operation signal is stopped, based on the revolution speed of the work implement 130 identified in step S4 (step S15). When the revolution angle will not reach the first target revolution angle by revolution due to inertia (step S15: NO), the movement control unit 616 generates a revolution operation signal in step S13, and the operation signal output unit 617 outputs the revolution operation signal to the control valve 123 in step S14.

On the other hand, when the determination is made that the revolution angle will reach the first target revolution angle by revolution due to inertia (step S15: YES), the movement control unit 616 determines whether the revolution angle has reached the target revolution angle and the posture of the work implement 130 is the target posture (step S16). When the revolution angle reaches the first target revolution angle without the posture of the work implement 130 being the target posture (step S16: NO), the control device 160 returns the processing to step S4.

On the other hand, when the revolution angle reaches the target revolution angle with the posture of the work implement 130 being the target posture (step S16: YES), the control device 160 ends the first revolution processing.

FIG. 7 is a flowchart illustrating the second revolution control by the control device 160 according to the first embodiment.

When the start switch 143SW is operated by the operator, the operation signal input unit 612 of the control device 160 receives input of an automatic control instruction signal.

In executing the second revolution, the control device 160 executes the second revolution control illustrated in FIG. 7. First, the measurement data acquisition unit 611 acquires the measurement data of the orientation of the loading machine 100 (step S21). The movement control unit 616 reads the target orientation (orientation toward the side of the loading target T) of the revolving body 120, the target posture, the wall height Ht of the loading target T, and the interference avoidance orientation from the storage 650 (step S22). The angle identification unit 615 identifies the second target revolution angle θₜ₂ and the second interference avoidance angle θₐ₂ based on the orientation in which the revolving body 120 is directed identified in step S21 and the target orientation and the interference avoidance orientation read in step S22 (step S23).

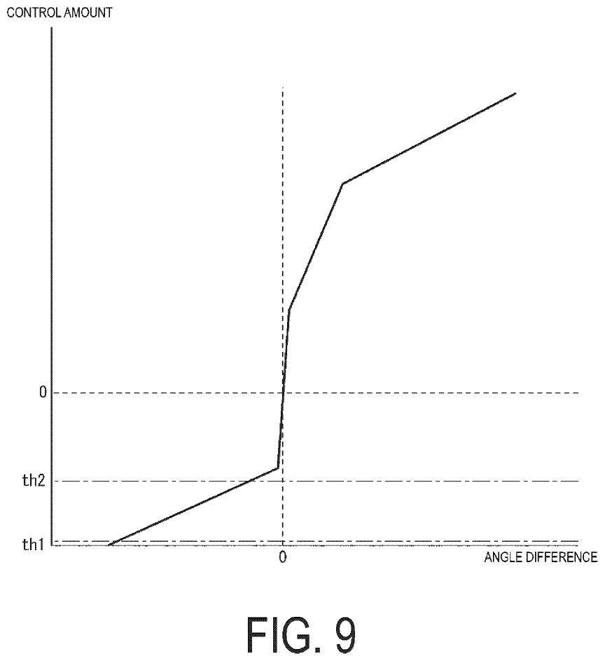

The movement control unit 616 determines the upper limit value of the control amount of the work implement 130 in the second revolution control (the absolute value of the control amount) based on the identified second target revolution angle θₜ₂ (step S24). FIG. 9 is a diagram illustrating an example of the upper limit value of the control amount according to the first embodiment. Specifically, the movement control unit 616 determines the upper limit value of the control amount to be a smaller value for a larger second target revolution angle θₜ₂. In the example illustrated in FIG. 9, for example, in a case where the upper limit value of the control amount is th1 when the second target revolution angle θₜ₂ is 90°, the upper limit value of the control amount when the second target revolution angle θₜ₂ is 180° is th2 which is closer to zero than th1. The movement control unit 616 determines the upper limit value of the control amount according to, for example, a predetermined table in which the second target revolution angle θₜ₂ and the upper limit value are associated with each other. The table may be created by examining, through observation of the operation of the skilled operator, the control amount of the work implement 130 such that the timing at which the revolution angle of the revolving body 120 reaches the second target revolution angle θₜ₂ and the timing at which the posture of the work implement 130 reaches the target posture substantially coincide with each other. Accordingly, a larger second target revolution angle θₜ₂ leads to a slower driving of the work implement 130.

Next, the measurement data acquisition unit 611 acquires the measurement data of each of the position, the orientation, the inclination angle, and the revolution speed of the loading machine 100, and the measurement data of the cylinder length of each cylinder (step S25). The work implement position identification unit 613 identifies the posture of the work implement 130 based on the measurement data (step S25). Thus, the work implement position identification unit 613 identifies the position of the distal end P of the arm 132, the position of the lowest point Q of the bucket 133, and the posture of the bucket 133.

The movement control unit 616 determines whether the work implement 130 is revolving (step S27). For example, when the revolution speed of the revolving body 120 is equal to or higher than a predetermined speed, the movement control unit 616 determines that the revolution is in progress. When the work implement 130 is not revolving (step S27: NO), the movement control unit 616 generates an automatic operation signal for revolving the revolving body 120 (step S29). The automatic operation signal is an operation signal for revolving the revolving body 120 from the inside of the loading target T toward the outside of the loading target T in plan view from above.

On the other hand, when the work implement 130 is revolving (step S27: YES), the movement control unit 616 determines whether the revolution angle of the work implement 130 will reach the target revolution angle by revolution due to inertia when the revolution operation signal is stopped, based on the measurement data of the revolution speed of the work implement 130 identified in step S25 (step S28). When the revolution angle of the work implement 130 will not reach the target revolution angle by the revolution due to inertia (step S28: NO), the movement control unit 616 generates an automatic operation signal for revolving the revolving body 120 (step S29). When the revolution angle of the work implement 130 will reach the second target revolution angle by revolution due to inertia (step S28: YES), the movement control unit 616 does not generate an automatic operation signal for revolving the revolving body 120.

Next, the movement control unit 616 determines whether the revolution angle of the revolving body 120 from the timing of starting the automatic control to the current time is less than the second interference avoidance angle θₐ₂ (step S30). When the revolution angle is less than the second interference avoidance angle θₐ₂ (step S30: YES), the movement control unit 616 generates an operation signal (neutral signal) for maintaining the posture of the work implement 130.

In step S30, when the revolution angle is equal to or greater than the second interference avoidance angle θₐ₂ (step S30: NO), the movement control unit 616 determines whether the posture of the work implement 130 identified in step S25 approximates the target posture identified in step S22 (step S31). When the posture of the work implement 130 does not approximate the target posture (step S31: NO), the movement control unit 616 calculates the control amount of the automatic operation signal based on the angle difference between the angle measurement value and the target posture and the control amount function illustrated in FIG. 8, for each of the boom 131, the arm 132, and the bucket 133 (step S32). Next, the movement control unit 616 generates the automatic operation signal that is limited so that the control amount does not exceed the upper limit value based on the upper limit value of the control amount determined in step S24 (step S33).

When the posture of the work implement 130 approximates the target posture (step S31: YES), the movement control unit 616 generates a neutral signal for maintaining the posture of the work implement 130.

Then, the operation signal output unit 617 outputs the generated automatic operation signal to the control valve 123 (step S34). The movement control unit 616 determines whether the revolution angle has reached the target revolution angle and the posture of the work implement 130 is the target posture (step S35). When the revolution angle has not reached the target revolution angle or the posture of the work implement 130 is not in the target posture (step S35: NO), the control device 160 returns the processing to step S25. On the other hand, when the revolution angle reaches the target revolution angle with the posture of the work implement 130 being the target posture (step S35: YES), the automatic control processing is ended.

### Actions and Effects

As described above, the control device 160 according to the first embodiment determines, at the time of the automatic control to make the bucket 133 move from above the loading target T to the target position outside the loading target T, the movement speed of the work implement 130 based on the second target revolution angle θₜ₂ from the direction in which the work implement 130 is directed at start of the automatic control to the direction in which the work implement 130 is directed to the target position. The control device 160 outputs a signal for moving the work implement 130 at the determined movement speed. Accordingly, in the automatic control of the loading machine 100, it is possible to avoid the risk of the bucket 133 coming into contact with a protruding portion of the ground.

In the first embodiment, the control device 160 determines the upper limit value of the control amount of the work implement 130 from the second target revolution angle θₜ₂, but this should not be construed in a limiting sense. For example, the control device 160 according to another embodiment may determine the gain of the control amount function based on the second target revolution angle θₜ₂. In other words, the control device 160 according to another embodiment may determine the slope of the control amount function based on the second target revolution angle θₜ₂. For example, the gain decreases, that is, the slope of the control amount functions decreases, as the second target revolution angle θₜ₂ increases. The gain is a value greater than 0 and equal to or less than 1.

### Second Embodiment

The control device 160 according to the first embodiment determines the control amount based on the difference between the measurement value of the angle of the work implement 130 and the target posture, and the second target revolution angle θₜ₂. In contrast, the control device 160 according to a second embodiment generates a target trajectory of the work implement 130 based on the second target revolution angle θₜ₂ and the target posture of the work implement 130, and moves the work implement 130 according to the target trajectory.

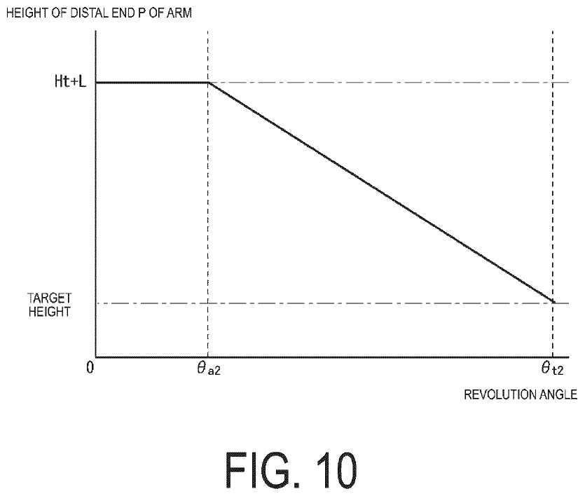

FIG. 10 is a diagram illustrating an example of the second target revolution angle θₜ₂ and a target trajectory of the work implement 130 according to the second embodiment. The movement control unit 616 of the control device 160 according to the second embodiment generates the target trajectory of the work implement 130 based on the determined second target revolution angle θₜ₂. The target trajectory is expressed as a function of the revolution angle of the revolving body 120, the height of the distal end P of the arm 132, and the distance in the depth direction from the revolution center to the distal end P (the radius of the arm 132). Note that the following description focuses on the relationship between the revolution angle and the height in the target trajectory. In the target trajectory, the height of the distal end P from the zero revolution angle to the second interference avoidance angle θₐ₂ is a height Ht+L that is higher than the wall height Ht by a length L of the bucket. In the target trajectory, the height of the distal end P from the second interference avoidance angle θₐ₂ to the second target revolution angle θₜ₂ is represented by a linear function in which the height monotonically decreases with respect to the revolution angle. Hereinafter, the function representing the height of the distal end P from the second interference avoidance angle θₐ₂ to the second target revolution angle θₜ₂ is referred to as a down function. The down function is a function passing through a point where the revolution angle is the second interference avoidance angle θₐ₂ and the height of the distal end P is Ht+L, and a point where the revolution angle is the second target revolution angle θₜ₂ and the height of the distal end P is the height of the distal end P when the work implement 130 takes the target posture. The down function according to another embodiment is not limited to a linear function, and may be another function such as an elliptic function or a cubic function. The down function is a function in which the height of the lowest point Q monotonically decreases with respect to the revolution angle. The down function may be a concave function. When the down function is a concave function, the time during which the bucket 133 is positioned near the ground during the revolution can be shortened. When the down function is a cubic function, excellent followability in the control can be achieved. The down function is a function indicating a relationship between the revolution angle of the revolving body 120 and the height of the bucket 133, and is a function in which the height of the bucket 133 when the revolution angle matches the second target revolution angle θₜ₂ becomes equal to the height of the target position. The relationship between the revolution angle in the target trajectory and the radius of the arm 132 is also the same as the relationship of the down function described above. The movement control unit 616 determines the radius of the arm 132 based on the target trajectory and the revolution angle.

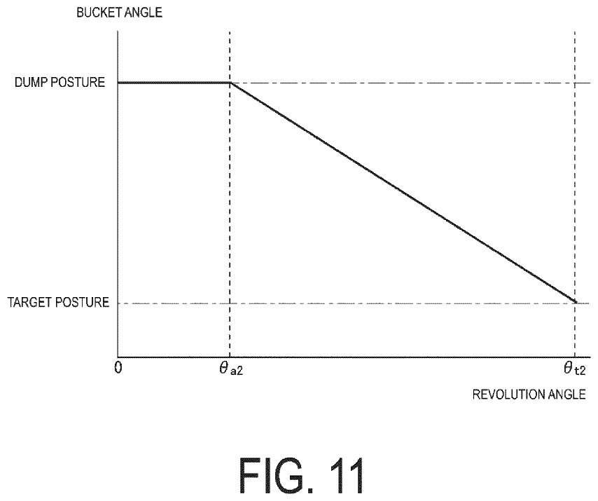

FIG. 11 is a diagram illustrating an example of the second target revolution angle θₜ₂ and the relative angle of the bucket 133 according to the second embodiment. The movement control unit 616 of the control device 160 according to the second embodiment generates a bucket function, which is a function of the revolution angle and the target value of the relative angle of the bucket 133, based on the determined second target revolution angle θₜ₂. In the bucket function, the relative angle of the bucket 133 from the zero revolution angle to the second interference avoidance angle θₐ₂ is the relative angle at the start of the second revolution. For example, according to the bucket function, the bucket 133 maintains the dumping posture from the zero revolution angle to the second interference avoidance angle θₐ₂. In the bucket function, the relative angle of the bucket 133 from the second interference avoidance angle θₐ₂ to the second target revolution angle θₜ₂ is represented by a linear function in which the angle monotonously changes with respect to the revolution angle. The bucket function is a function passing through a point where the revolution angle is the second interference avoidance angle θₐ₂ and the relative angle of the bucket 133 is the relative angle at the start of the second revolution and a point where the revolution angle is the second target revolution angle θₜ₂ and the relative angle of the bucket 133 is the relative angle of the bucket 133 when the work implement 130 takes the target posture.

When the revolution angle reaches the second interference avoidance angle θₐ₂, the movement control unit 616 generates the automatic operation signal through the following procedure.

The movement control unit 616 determines a provisional target height and a provisional target radius of the lowest point of the distal end P of the arm 132 as well as a provisional target speed of the distal end P of the arm 132 based on the current revolution angle, revolution speed, and down function. The provisional target height is a height corresponding to the revolution angle at the next control timing in the down function. The provisional target speed is the slope of a tangent at a point represented by the provisional target height and the provisional target radius in the down function. The movement control unit 616 determines provisional target angles of the boom 131 and the arm 132 from the provisional target height and the provisional target radius. The movement control unit 616 determines the provisional target angular velocity of the boom 131 and the arm 132 from the provisional target speed. The movement control unit 616 determines the control amounts of the boom 131 and the arm 132 by PID control based on the provisional target angle and the provisional target angular velocity. Here, the provisional target angle is a feedback term of the PID control, and the provisional target angular velocity is a feedforward term of the PID control.

The provisional target angle of the bucket 133 and the provisional target angular velocity of the bucket 133 are determined based on the current revolution angle, revolution speed, and bucket function. The provisional target angle is an angle corresponding to the revolution angle at the next control timing in the bucket function. The provisional target angular velocity is the slope of a tangent at a point represented by the provisional target angle in the bucket function. The movement control unit 616 determines the control amounts of the bucket 133 by PID control based on the provisional target angle and the provisional target angular velocity. Here, the provisional target angle is a feedback term of the PID control, and the provisional target angular velocity is a feedforward term of the PID control.

As described above, the control device 160 according to the second embodiment determines, at the time of the automatic control to make the bucket 133 move from above the loading target T to the target position outside the loading target T, the movement speed of the work implement 130 based on the second target revolution angle θₜ₂ from the direction in which the work implement 130 is directed at start of the automatic control to the direction in which the work implement 130 is directed to the target position, the position of the work implement 130, and the down function, as in the first embodiment. The control device 160 outputs a signal for moving the work implement 130 at the determined movement speed. Accordingly, in the automatic control of the loading machine 100, it is possible to avoid the risk of the bucket 133 coming into contact with a protruding portion of the ground.

### Third Embodiment

The control device 160 according to the first embodiment determines the control amount based on the difference between the measurement value of the angle of the work implement 130 and the target posture, and the second target revolution angle θₜ₂. In contrast, the control device 160 according to a third embodiment determines the timing of lowering the work implement 130 based on the second target revolution angle θₜ₂, and moves the work implement 130 according to the timing.

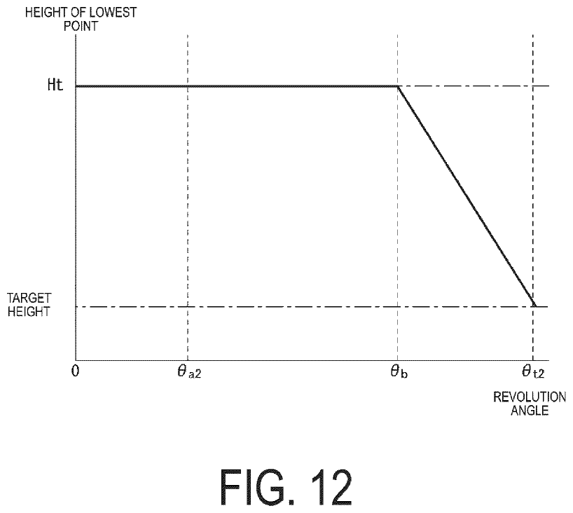

FIG. 12 is a diagram illustrating the second target revolution angle θₜ₂ and the timing of lowering the work implement 130 according to the third embodiment. The movement control unit 616 of the control device 160 according to the third embodiment calculates a time t1 required for the work implement 130 to reach the target posture when the boom 131, the arm 132, and the bucket 133 are driven at a predetermined angular velocity based on a difference between the posture of the work implement 130 at the start of the second revolution and the target posture. For example, the movement control unit 616 calculates the time t1 required for the work implement 130 to reach the target posture when the boom 131, the arm 132, and the bucket 133 are driven at the predetermined angular velocity according to the control amount function illustrated in FIG. 8. The movement control unit 616 calculates a revolution time t2 required for the revolving body 120 to revolve to the second target revolution angle θₜ₂. The movement control unit 616 determines a timing (t2−t1) of lowering the work implement 130 by subtracting the time t1 required for the work implement 130 to reach the target posture from the calculated revolution time t2 required for the revolution. The movement control unit 616 determines a lowering start angle θ_{b} at which the work implement 130 starts to move by converting the determined timing (t2−t1) into a revolution angle.

When the revolution angle reaches the second interference avoidance angle θₐ₂, the movement control unit 616 generates the automatic operation signal through the following procedure.

The movement control unit 616 determines whether the current revolution angle has reached a lowering start angle θ_{b}. When the current revolution angle is less than the lowering start angle θ_{b}, the movement control unit 616 generates an operation signal (neutral signal) for maintaining the posture of the work implement 130. On the other hand, when the current revolution angle has reached the lowering start angle θ_{b}, the movement control unit 616 generates the automatic operation signal for the boom 131, the arm 132, and the bucket 133 with the control amount based on the control amount function illustrated in FIG. 8.

As described above, the control device 160 according to the third embodiment determines, at the time of the automatic control to make the bucket 133 move from above the loading target T to the target position outside the loading target T, the lowering start timing of the work implement 130 based on the second target revolution angle θₜ₂ from the direction in which the work implement 130 is directed at start of the automatic control to the direction in which the work implement 130 is directed to the target position, as in the first embodiment. The control device 160 outputs a signal for moving the work implement 130 at the determined lowering start timing. Accordingly, in the automatic control of the loading machine 100, it is possible to avoid the risk of the bucket 133 coming into contact with a protruding portion of the ground. Note that determining the lowering timing of the work implement 130 based on the second target revolution angle θₜ₂ by the control device 160 according to the third embodiment is equivalent to determining whether to set the movement speed of the work implement 130 to zero based on the second target revolution angle θₜ₂ or to set the movement speed according to the control amount function illustrated in FIG. 8.

As illustrated in FIG. 12, determining the lowering timing of the work implement 130 based on the second target revolution angle θₜ₂ by the control device 160 according to the third embodiment is equivalent to determining a function indicating the relationship between the revolution angle of the revolving body 120 and the height of the bucket 133, the function being a function with which the height of the bucket 133 when the revolution angle matches the second target revolution angle θₜ₂ becomes equal to the height of the target position. The function illustrated in FIG. 12 includes a first section (from 0 to θ_{b}) in which the height of the bucket 133 is constant, and a second section (from θ_{b} to θₜ₂) in which the height of the bucket 133 constantly moves in the downward direction.

### Other Embodiments

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel.

The control device 160 according to the embodiment described above may be constituted by a single computer. The configuration of the control device 160 may be divided into a plurality of computers, and the plurality of computers may cooperate with each other and serve as the control device 160. At this time, some of the computers constituting the control device 160 may be mounted inside the loading machine 100, and the other computers may be provided outside of the loading machine 100.

The target posture, the target orientation, the interference avoidance orientation, and the wall height Ht according to the embodiment described above are recorded in the storage 650 by teaching, but are not limited thereto. For example, the loading machine 100 according to another embodiment may recognize the position and a shape of the loading target T by being provided with a three-dimensional measurement device such as a stereo camera or light detection and ranging (LiDAR), and may identify the target posture, the target orientation, the interference avoidance orientation, and the wall height Ht based on the position and the shape. That is, the reference identification unit 614 may identify the target posture, the target orientation, the interference avoidance orientation, and the wall height Ht based on shape data of the loading target T. Further, in another embodiment, the position, the posture, and the orientation of the loading target T may be received through communication with the loading target T, and the target posture, the target orientation, the interference avoidance orientation, and the wall height Ht may be identified based on the position, the posture, and the orientation of the loading target T and the known shape of the loading target T. In another embodiment, when the loading target T automatically travels by communication with the control apparatus, the position and the orientation of the loading target T may be received from the control apparatus, and the target posture, the target orientation, the interference avoidance orientation, and the wall height Ht may be identified based on the position and the orientation of the loading target T and the known shape of the loading target T. Further, in another embodiment, the reference identification unit 614 may identify the target posture, the target orientation, the interference avoidance orientation, and the wall height Ht based on inputs to the operation terminal 142 by the operator. Further, the loading machine 100 according to another embodiment may identify the target posture, the target orientation, and the interference avoidance orientation separately from identification of the wall height Ht. That is, in another embodiment, the control device 160 may separately include a first reference identification unit that identifies the target posture, the target orientation, and the interference avoidance orientation, and a second reference identification unit that identifies the wall height Ht. For example, the loading machine 100 may identify the target posture, the target orientation, and the interference avoidance orientation by teaching, and identify the wall height Ht by an input by the operator. Further, the operator may identify the wall height that is the height of the loading target by inputting the vehicle type of loading machine. That is, the control device 160 identifies the wall height Ht by reading the height associated with the input vehicle type from a table in which the vehicle types and the wall heights are associated with one another in advance.

Further, the control device 160 according to the embodiment described above identifies the posture of the work implement 130 based on the measurement data of the sensor that measures the posture of the work implement 130, but is not limited thereto. For example, in another embodiment, when the loading machine 100 includes a three-dimensional measurement device such as a stereo camera or a LiDAR, the posture of the work implement 130, in particular, the height of the lowest point Q of the bucket 133, may be recognized based on the measurement data of the three-dimensional measurement device, and the automatic control may be performed based on the recognized posture.

The control device 160 according to the embodiment described above calculates the angle of the revolving body 120 by integrating the angular velocity of the revolving body 120 measured by the inclination measuring instrument 152, but is not limited thereto. For example, the control device 160 according to another embodiment may calculate the angle of the revolving body 120 based on a difference in orientation measured by the position and orientation calculator 151. In another embodiment, the angle of the revolving body 120 may be identified using a detection value of a revolution angle sensor provided in the revolution motor 124.

The control device 160 according to the embodiment described above performs the automatic control based on the comparison between the revolution angle and the interference avoidance angle, but is not limited thereto. For example, the control device 160 according to another embodiment may perform the automatic control based on a comparison between the position of the bucket 133 and a rearmost point of the outer shape of the loading target T in the revolution direction of the revolving body 120. For example, the control device 160 according to another embodiment may adjust the revolution start timing so that the bucket 133 is positioned in a region in the vicinity of the rearmost point in the revolution direction of the revolving body 120.

Further, in another embodiment, the control device 160 may generate an automatic control signal for each link part and the revolving body 120 so that the bucket 133 passes through a trajectory designated in advance. For example, the trajectory may be determined by fitting with a predetermined curve function, or may be determined by teaching by a manual operation. The trajectory may be represented by a time-series arrangement of the postures of the bucket 133, the postures of the link parts and the revolving body 120, or the operation signals.

The loading machine 100 according to the embodiment described above is directly operated by the operator riding in the cab 140, but is not limited thereto. For example, the loading machine 100 according to another embodiment may be operated by remote operation. A remote operation system according to another embodiment includes, for example, the operation device 143 provided remotely from the loading machine 100, a display device that displays an image of an environment of the loading machine 100, and a remote control device that communicates with the loading machine 100. When the operator operates the operation device 143 of the remote operation system, the remote control device transmits an operation signal to the control device 160 by communication. In this case, the function of the control device 160 may be implemented in the remote control device, or may be implemented in the loading machine 100 and the remote control device in a distributed manner.

In the automatic control according to the embodiment described above, the first revolution in which the bucket 133 is moved from the position at the time of completion of excavation to the loading point and the second revolution in which movement to the position for starting the next excavation occurs are respectively executed, but the automatic control is not limited thereto. For example, in another embodiment, the control device 160 may perform the fully automatic control for automatically executing a series of operations of a first revolution operation, an earth discharge operation, and a second revolution operation. Further, for example, in another embodiment, the control device 160 may execute only the second revolution without executing the first revolution.

Further, the automatic control according to the embodiment described above is started by the operation on the start switch 143SW by the operator, but is not limited thereto. For example, in another embodiment, the control device 160 may autonomously determine the start timing of the automatic control and start the automatic control regardless of the operation on the start switch 143SW.

### INDUSTRIAL APPLICABILITY

According to the above embodiments, it is possible to reduce a risk of a work tool coming into contact with the ground when a loading machine automatically revolves while lowering a work implement.

### REFERENCE SIGNS LIST

100 Loading machine, 110 Traveling body, 111 Endless track, 112 Travel motor, 120 revolving body, 121 Engine, 122 Hydraulic pump, 123 Control valve, 124 Revolution motor, 130 Work implement, 131 Boom, 131C Boom cylinder, 132 Arm, 132C Arm cylinder, 133 Bucket, 133C Bucket cylinder, 140 Cab, 141 Operator seat, 142 Operation terminal, 143 Operation device, 151 Position and orientation calculator, 152 Inclination measuring instrument, 153 Boom stroke sensor, 154 Arm stroke sensor, 155 Bucket stroke sensor, 160 Control device, 610 Processor, 611 Measurement data acquisition unit, 612 Operation signal input unit, 613 Work implement position identification unit, 614 Reference identification unit, 615 Angle identification unit, 616 Movement control unit, 617 Operation signal output unit, 630 Main memory, 650 Storage, 670 Interface

1. A control device for a loading machine comprising:
a revolving body configured to revolve about a revolution center; and
a work implement attached to the revolving body and including a work tool, the control device
determining, at time of automatic control to make the work tool move from above a loading target to a target position outside the loading target, a movement speed of the work implement based on a target revolution angle to a direction in which the work implement is directed to the target position, and
outputting a signal to make the work implement move at the movement speed determined.

2. The control device for a loading machine according to claim 1, wherein
the target revolution angle is a revolution angle from a direction in which the work implement is directed at start of the automatic control to the direction in which the work implement is directed to the target position.

3. The control device for a loading machine according to claim 1, wherein
the movement speed of the work implement is decreased as the target revolution angle increases.

4. The control device for a loading machine according to claim 3, wherein
an upper limit value of the movement speed of the work implement is decreased as the target revolution angle increases,
the movement speed of the work implement is calculated based on a target posture of the work implement determined based on the target position and a posture of the work implement, and
the movement speed of the work implement is limited based on the upper limit value.

5. The control device for a loading machine according to claim 1, wherein
a function is determined that indicates a relationship between a revolution angle of the revolving body and a height of the work tool, the function being a function with which the height of the work tool is equal to a height of the target position when the revolution angle matches the target revolution angle, and
the movement speed of the work tool is determined based on the revolution angle of the revolving body, the height of the work tool, and the function.

6. The control device for a loading machine according to claim 5, wherein
the movement speed of the work tool is determined based on a revolution speed of the revolving body, the revolution angle of the revolving body, the height of the work tool, and the function.

7. The control device for a loading machine according to claim 5, wherein
the function includes a first section in which the height of the work tool is constant and a second section in which the height of the work tool moves downward, and
a timing of switching between the first section and the second section is determined based on the target revolution angle.

8. A control method for a loading machine including a revolving body configured to revolve about a revolution center, and a work implement attached to the revolving body and including a work tool, the control method comprising:
determining, at time of automatic control to make the work tool move from above a loading target to a target position outside the loading target, a movement speed of the work implement based on a target revolution angle to a direction in which the work implement is directed to the target position; and
outputting a signal to make the work implement move at the movement speed determined.

9. A remote operation system for a loading machine including a revolving body configured to revolve about a revolution center and a work implement attached to the revolving body and including a work tool, the remote operation system comprising:
a display device; and
an operation device, both at a remote location, wherein
the remote operation system determines, at time of automatic control to make the work tool move from above a loading target to a target position outside the loading target, a movement speed of the work implement based on a target revolution angle to a direction in which the work implement is directed to the target position, and
the remote operation system outputs a signal to make the work implement move at the movement speed determined, to the loading machine.
